(19) United States
(12) Patent Application Publication
(10) Pub. No.: US 2010/0056275 A1
(43) Pub. Date: Mar. 4, 2010

(54) Massively Multiplayer Online Game Technologies

(75) Inventors: Bret D. Wilson, White Sands, NY (US); Eugene C. Wardynski, West Paint, NY (US)

Correspondence Address: DEPARTMENT OF THE ARMY;LEGAL OFFICE, AMSAM - L - G - I, U.S. ARMY AVIATION & MISSILE COMMAND, REDSTONE ARSENAL, AL, 35898-5000, US

(73) Assignee: United States of America as Represented by the Secretary of the Army, Washington, DC (US)

(21) Appl. No.: 12/553,821

(22) Filed: Sep. 3, 2009

Related U.S. Application Data
(60) Provisional application No. 61/094,342, filed on Sep. 4, 2008.

(51) Int. Cl. A63F 13/00; A63F 9/24

(52) U.S. Cl. 463/32; 463/43; 463/42

(57) ABSTRACT

A method for providing connectivity information and customized media content to clients of an interactive 3-D simulation executing on at least one game server is provided. The method includes receiving a message from an authentication source indicating authentication of a client and receiving a request from the client demanding a list of operational game servers and an address for each of the operational game servers. The method further includes sending a request to a second server for a list of operational game servers. The method further includes receiving a message from the second server including a list of game servers, wherein each of the game servers in the list has periodically authenticated with the second server in real time during execution of the interactive 3-D simulation. The method further includes providing the client with a list of game servers and an address for each of the operational game servers. The method further includes providing customized media content delivery to the client.

### PRIORITY CLAIMED

Benefit is claimed to provisional application No. 61/094,342 of the same title which was filed on Sep. 4, 2008.

### STATEMENT OF GOVERNMENT INTEREST

The invention described herein may be manufactured, used and/or licensed by or for the U.S. Government for governmental purposes without the payment of royalties by the U.S. Government to the inventors.

### FIELD OF THE INVENTION

This invention relates to the field of online simulations and video games and more particularly relates to the field of management of various aspects of online simulations and video games.

### BACKGROUND OF THE INVENTION

With the growing number of people having access to a computer, video games and simulations are becoming more widespread, especially among the younger generation. However, the development of computer graphics, and especially 3D graphics, has allowed the games and simulations to become more sophisticated. Also facilitating the emergence of more sophisticated games and simulations is the emergence of faster personal computers with more powerful CPUs and with more Random Access Memory (RAM).

The more sophisticated games and simulations have, in turn, expanded the computer game market by attracting a more mature consumer base. In recent years, the Internet and, in particular, the World Wide Web portion of the Internet has experienced a rapid growth. In this regard, the Internet has begun to accommodate games and simulations, known as online games. A plethora of multiplayer online games and simulations have appeared on the Internet/Web.

A further characteristic of such online games and simulations is that each player must download or otherwise install game software to supplement the functionality of the player's computer system.

Online games and simulations can be classified according to the number of players that can play the game. There are single player online games and simulations in which only one player is involved and multiplayer online games and simulations in which a plurality of players are involved. MMOGs (Massively Multiplayer Online Games) are large-scale multiplayer online games and simulations that allow huge numbers of players to participate in game-play at once. MMOGs are truly massive and allow thousands of gamers to join the game world and simultaneously interact in that game. When users join the game they continue playing, regardless of who else is on at the same time. Each of a multitude of game servers in MMOGs usually hold at least a thousand players and the game servers run the environments for a particular part of the game world. Good MMOGs will be made of several game servers, each providing a part of the world and will allow gamers to traverse between the game servers in essence, allowing gamers to travel to different parts of the game world.

One of the obstacles experienced by MMOGs is the problem of managing large numbers of players and the data and statistics associated with the players, such as personal user data. Further, an MMOG can produce large amounts of statistics of various types and sizes, which may be generated during game events or through game and server usage. In order to adequately analyze and draw conclusions from an MMOG, all of this data must be collected frequently, in an expedited manner, and stored in a proper fashion.

Another obstacle associated with MMOGs is the ability to customize each user's experience. With the large numbers of players involved in an MMOG, it can be a challenge to determine how to customize a user's experience such that each of the many thousands of users experience a unique encounter. A further challenge is to generate criteria for customizing each user's experience, when large amounts of statistical data are available for each user. Also, with the higher fidelity and sophisticated desires of video game and simulation users today, it is desirable to provide the above customizations in a faster and more seamless mode. Solutions to the above obstacles produce the additional problems of managing the vast amounts of user accounts, user statistics, media content used to customize user's experiences and various rules or criteria used to customize user's experiences. This information must be administrated and maintained by administrators that require access and permissions to read, write, modify, delete and/or execute this data. It is further desirable that before granting access and permissions to administrators, an authentication process must be in place.

Another problem with MMOGs is the management of authorized access to the game servers. MMOGs require a system for allowing authorized players to access the game servers while denying access to unauthorized players. It is further desirable that this system of authorization be executed periodically throughout the duration of a video game or simulation.

Yet another problem with MMOGs is matching each of the multitude of players with a corresponding game server (out of many) so as to optimize the game performance perceived by the player. Players are often provided with a list of game servers that are online, though many of them may not currently be serving the video game or simulation.

Players then visit each game server provided in the list and through trial-and-error find a game server currently serving the video game or simulation. It is desirable to provide players with a list of game servers that are both online and currently serving the video game or simulation.

Therefore, a need exists to overcome the problems with the prior art as discussed above, and particularly for a more efficient way to manage various aspects of massively multiplayer online games and simulations.

### SUMMARY OF THE INVENTION

According to one embodiment of the present invention, a method executed on a first server for facilitating an interactive 3-D simulation, the method for providing connectivity information to clients of an interactive 3-D simulation executing on at least one game server, is provided. The method includes receiving a message from an authentication source indicating authentication of a client and receiving a request from the client demanding a list of operational game servers serving the interactive 3-D simulation and an address for each of the operational game servers.

The method further includes sending a request to a second server for a list of operational game servers serving the interactive 3-D simulation. The method further includes receiving a message from the second server including a list of game servers serving the interactive 3-D simulation, wherein each of the game servers in the list has periodically authenticated with the second server in real time during execution of the interactive 3-D simulation. The method further includes providing the client with a list of game servers serving the interactive 3-D simulation and an address for each of the operational game servers.

According to another embodiment of the present invention, a computer readable medium including computer instructions for execution on a first server for facilitating an interactive 3-D simulation, the computer instructions for providing connectivity information to clients of an interactive 3-D simulation executing on at least one game server, is provided. The computer instructions comprise instructions for receiving a message from an authentication source indicating authentication of a client and receiving a request from the client demanding a list of operational game servers serving the interactive 3-D simulation and an address for each of the operational game servers. The computer instructions further comprise instructions for sending a request to a second server for a list of operational game servers serving the interactive 3-D simulation. The computer instructions further comprise instructions for receiving a message from the second server including a list of game servers serving the interactive 3-D simulation, wherein each of the game servers in the list has periodically authenticated with the second server in real time during execution of the interactive 3-D simulation. The computer instructions further comprise instructions for providing the client with a list of game servers serving the interactive 3-D simulation and an address for each of the operational game servers.

According to one embodiment of the present invention, a first server for facilitating an interactive 3-D simulation, the first server for providing connectivity information to clients of an interactive 3-D simulation executing on at least one game server, is provided. The first server includes a receiver for receiving a message from an authentication source indicating authentication of a client, receiving a request from the client demanding a list of operational game servers serving the interactive 3-D simulation and an address for each of the operational game servers and receiving a message from a second server including a list of game servers serving the interactive 3-D simulation.

Thus, each of the game servers in the list has been periodically authenticated with the second server in real time during execution of the interactive 3-D simulation. The first server further includes a transmitter for sending to the client a list of game servers serving the interactive 3-D simulation and an address for each of the operational game servers.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 is a block diagram showing a high level system architecture of an online game management system 100, according to one embodiment of the present invention.

FIG. 2 is a block diagram showing a high level system architecture of a statistical tracking service process of an online game system 100, according to one embodiment of the present invention.

FIG. 3 is a block diagram showing a message transmission process of a statistical tracking service process of an online game system 100, according to one embodiment of the present invention.

FIG. 4 is a flowchart showing the control flow of the production and transmission of messages of a statistical tracking service process of an online game system 100, according to one embodiment of the present invention.

FIG. 5 is a flowchart showing the control flow of the reception and processing of messages of a statistical tracking service process of an online game system 100, according to one embodiment of the present invention.

FIG. 6 is a block diagram showing a high level system architecture of an authentication process of an online game system 100, according to one embodiment of the present invention.

FIG. 7 is a flowchart showing the control flow of the continuous authentication process of an online game system 100, according to one embodiment of the present invention.

FIG. 8 is a block diagram showing a high level system architecture of a media content customization process of an online game system 100, according to one embodiment of the present invention.

FIG. 9 is a flowchart showing the control flow of the customized media content delivery process of an online game system 100, according to one embodiment of the present invention.

FIG. 10 is a block diagram showing a high level system architecture of an inference engine process of an online game system 100, according to one embodiment of the present invention.

FIG. 11 is a flowchart showing the control flow of the inference engine process of an online game system 100, according to one embodiment of the present invention.

FIG. 12 is a block diagram showing a high level system architecture of a client-server matchmaking process of an online game system 100, according to one embodiment of the present invention.

FIG. 13 is a flowchart showing the control flow of the client-server matchmaking process of an online game system 100, according to one embodiment of the present invention.

FIG. 14 is a block diagram showing a high level system architecture of a statistical data analysis process of an online game system 100, according to one embodiment of the present invention.

FIG. 15 is a flowchart showing the control flow of the user access process of an online game system 100, according to one embodiment of the present invention.

FIG. 16 is a block diagram showing an embodiment of a computer system useful for implementing an embodiment of the present invention.

### DETAILED DESCRIPTION OF THE INVENTION

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawing like numerals refer to like parts through several views.

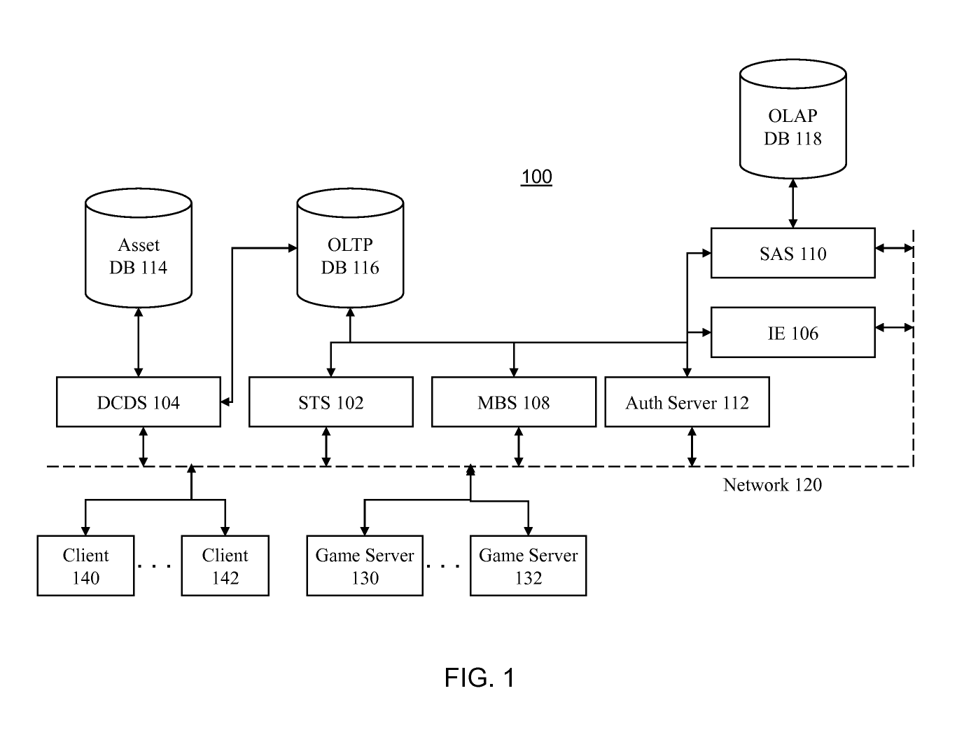

FIG. 1 is a block diagram showing a high level system architecture of an online game management system 100, according to one embodiment of the present invention. FIG. 1 illustrates the client-server architecture of one embodiment of the present invention. The exemplary embodiments of the present invention adhere to the system architecture of FIG. 1. FIG. 1 shows an embodiment of the present invention wherein clients interact with an online game management system 100 over a network 120, such as in an enterprise implementation of the management system 100 that services multiple clients in more than one location.

FIG. 1 shows client computers 140 through 142 connected to a network 120. Client computers 140-142 comprise players running a client application on the client computer so as to participate in an online game. The execute client applications may be compiled or interpreted executable modules written, for example, in C++, HTML or any self-sufficient application executing on a client computer. FIG. 1 further shows game servers 130-132 connected to a network 120. Game servers 130-132 comprise servers running a server application so as to provide an online game to the clients 140-142.

FIG. 1 shows an embodiment of the present invention wherein clients 140-142 interact with game servers 130-132 over a network 120, such as in an Internet implementation of a network application that services multiple users in more than one location and for multiple tasks.

In one embodiment of the present invention, the network application of FIG. 1 is a client-server application having a client portion that resides on the computers of clients 140-142 and a server application that resides on game servers 130-132. For example, the network application can be a network or multi-player 3D (three-dimensional) simulation or video game, such as a first person shooter, that is played by clients 140-142 via network 120 using any one of the game servers 130-132 as a network hub.

A multiplayer game is a video game in which more than one player can play the same game at the same time. In multiplayer games, players either all compete against each other, or team up to achieve a common goal such as defeating an enemy that can consist of either computer or human players. Usually multiplayer games allow players play together by connecting multiple computers via a network, usually either a LAN or the Internet.

It should be noted that although FIG. 1 shows only two client computers 140 and 142, the system of the present invention supports any number of client computers. Also, although FIG. 1 shows only two game servers 130, 132, the system of the present invention supports any number of game servers.

It should be noted that in the embodiment of the present invention described above, the game servers 130-132 are depicted as separate from the servers 102-112. In this embodiment, the game servers 130-132 communicate over a network 120 with servers 102-112. In an alternative embodiment of the present invention, any two or all of the game servers 130-132 and servers 102-112 can be integrated. In this alternative embodiment, the integrated elements share the same resources.

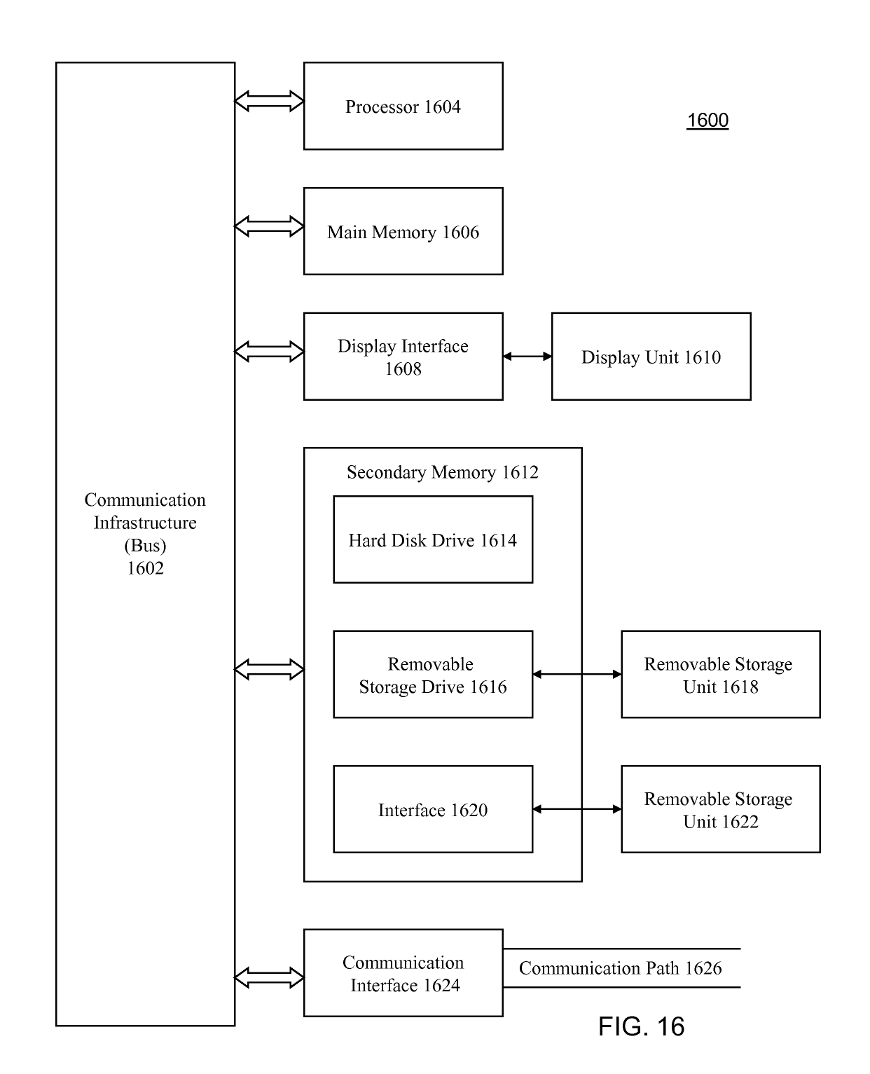

In an embodiment of the present invention, the computer systems of client computers 140 through 142, servers 130-132 and servers 102-112 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the computer systems of client computers 140 through 142, servers 130-132 and servers 102-112 are a server system, such as SUN Ultra workstations running a SunOS operating system or IBM RS/6000 workstations and servers running the AIX operating system. The computer systems of client computers 140 through 142, servers 130-132 and servers 102-112 are described in greater detail below with reference to FIG. 16.

In an embodiment of the present invention, the network 120 is a circuit switched network, such as the Public Service Telephone Network (PSTN). In another embodiment, the network 120 is a packet switched network. The packet switched network is a wide area network (WAN), such as the global Internet, a private WAN, a local area network (LAN), a telecommunications network or any combination of the above-mentioned networks.

In yet another embodiment, the structure of the network 120 is a wired network, a wireless network, a broadcast network or a point-to-point network.

The online game management system 100 of FIG. 1 includes a system having a plurality of servers or modules that each performs a separate function. The Statistical Tracking Service (STS) server 102 performs statistical tracking functions described in more detail below.

The STS module 102 includes a receiver for receiving statistical data from client applications and a storage capability. The Dynamic Content Delivery Service (DCDS) server 104 performs customized media content delivery functions described in more detail below. The Dynamic Content Delivery Service (DCDS) server 104 selects targeted media content to send to each client application based on statistical data received from each client application and sends to each client application the targeted media content that was selected. The DCDS server 104 includes a database for storing the media content and a transmitter for sending targeted content to client applications. There also exists a receiver at client applications for receiving targeted media content sent by the DCDS server 104.

The Inference Engine (IE) server 106 performs processing functions described in greater detail below. The IE server 106 executes pre-loaded rules upon existing statistical data to select media content for delivery to clients. The Master Browser System (MBS) server 108 performs matchmaking functions described in greater detail below. The MBS server 108 selects for each client application (140-142) a game server (130-132) that provides optimal game performance to each client application and directs each client application to a game server that was selected for that client application.

The Server Authentication Service (SAS) server 110 performs statistical data displaying and analysis functions, together with user access functions, described in greater detail below. The SAS server 110 provides various privileged views and displays of statistical data collected by the STS server 102 and provides analysis of the same statistical data.

The authentication server 112 performs authentication functions described in greater detail below. The authentication server 112 provides for authentication of a plurality of client applications seeking to engage in the online game by, for example, prompting client applications for credentials.

FIG. 1 shows the DCDS server 104 connected to an asset database 114, which is described in more detail below. An asset, also known as a media element, can be an image, audio, video, a texture, a 3D model, and an animation. Multiple assets are often combined into a single file, such as a binary file, called a package. Each asset and package has a name, which may be included in the package file as part of the content of the file.

FIG. 1 further shows DCDS server 104, STS server 102, MBS server 108, inference engine server 106 and authentication server 112 and SAS server 110 connected to On-Line Transaction Processing (OLTP) database 116, which is described in further detail below. OLTP refers to a class of systems that facilitate and manage transaction-oriented applications, typically for data entry and retrieval transaction processing. The OLTP software that manages database 116 uses client/server processing and brokering software that allows transactions to run on different computer platforms in the network 120. The manager for database 116 uses transaction management software and/or database optimization tactics to facilitate the processing of large numbers of concurrent updates to the OLTP-oriented database 116.

FIG. 1 shows the SAS server 110 connected to an On-Line Analytical Processing (OLAP) database 118, which is described in more detail below. OLAP is an approach to quickly providing answers to analytical queries that are multidimensional in nature. OLAP comprises a variety of services including Extract transform load (ETL), relational reporting and data mining. OLAP is used for reporting and planning marketing, reporting, business process management (BPM), transaction reporting and similar areas. The OLAP database 118 employs a multidimensional data model, allowing for complex analytical and ad-hoc queries with a rapid execution time leading to fast analysis of shared multidimensional information. The output of an OLAP query is typically displayed in a matrix format. The dimensions form the row and column of the matrix; the measures, the values. Multidimensional Expressions (MDX) is the standard query language for the OLAP database 118.

Optionally, any one of the servers 130-132 or 102-112 includes a Web server that connects to the network 120 via a network interface. In this embodiment, the server in question is logically connected to the Web server, which provides a Web interface available to clients (such as clients 140 through 142). This option is advantageous as a Web interface allows any clients having a Web connection to connect to the server in question. A Web interface provides a simple, efficient, highly compatible, economical and highly available connection to a server for a wide range of clients.

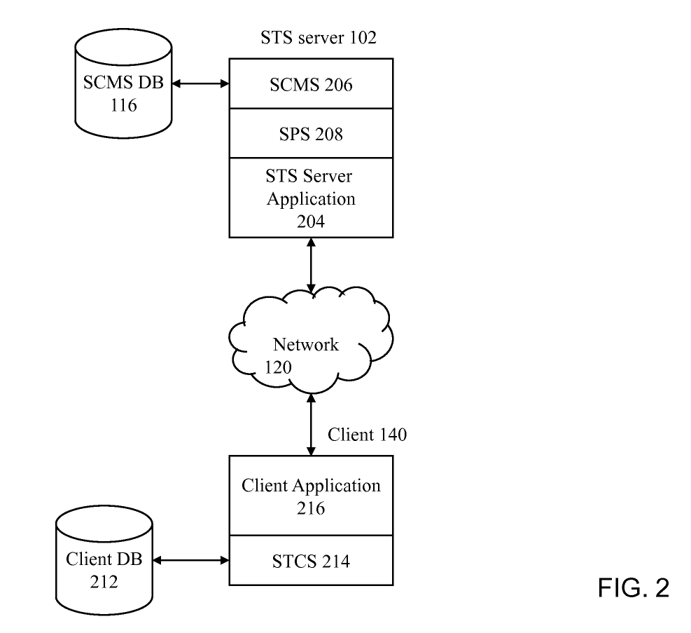

FIG. 2 is a block diagram showing a high level system architecture of a statistical tracking service process of an online game system 100, according to one embodiment of the present invention. FIG. 2 provides more detail about STS server 102 of FIG. 1. The STS server 102 collects and stores various types of information for each client engaging in the simulation or video game of the system 100.

Examples of statistical data that is collected and stored include unique identifiers for an event, a game, a user, a server, or a character. Other examples of statistical data include types of game events, time of events, an identifier for a user that initiated an event, a value for an event passed, severity of an event, duration of an event, the value of an event before/after a change was applied, the IP address of a user/character/server, administrative comments, and location or geographical information for a user/character/server. Other examples of statistical data include time of user logon, time of user logoff, number of hours played by each user, number of shots fired by each user, marksmanship rating for each user and level of game play by each user.

An event occurring during execution of the simulation or video may be referred to as a statistical event and may be defined using an event definition, such as a piece of text that describes the event. Following is a non-exhaustive list of statistics, some corresponding to statistical events and some corresponding to static data, that may be collected and stored by the STS server 102:
Quit: Number of times the player has quit the server
TimePlayed: Time played on the server
TimeAlive: Time spent alive on the server
RoundsStarted: Number of rounds that the player at least started in
RoundsWon: Number of rounds player was on the winning side
RoundsLost: Number of rounds player was on the losing side
RoundsSurvivedWon: Number of rounds player was on the winning side and remained alive until the round end
RoundsSurvivedLost: Number of rounds player was on the losing side and remained alive until the round end
SecondsAsSQL: Time in seconds the player was the squad leader
SecondsAsFTL: Time in seconds the player was the fireteam leader
SecondsAsSoldier: Time in seconds the player spent as a regular soldier
Kills Number: Number of enemies killed
Deaths: Number of times the player died
SecondsLinkedToSQL: Time in seconds the player was linked to the squad leader
SecondsLinkedToFTL: Time in seconds the player was linked to the fireteam leader
SecondsLinkedToSoldiers: Time in seconds the player was linked to other soldiers
UsedMedic: Number of times player started as a medic
Healed: Number of times player was healed by a medic
MedPaksUsed: Number of medical packs used by the player as a medic
Score: Player's total score
ROE: Player's Rules of Engagement violation total score
CapturedObjective: Number of times player captured the objective
ObjectiveDeaths: Number of times player died while attempting to capture an objective
AdminKicked: Number of times player was kicked by a server administrator
ShotsFiredGrenade: Number of times player used a grenade-class weapons
ShotsFiredAstRifle: Number of shots player fired with an assault rifle weapon
ShotsFiredPistol: Number of shots player fired with a pistol weapon
ShotsFiredMG: Number of shots player fired with a machine gun weapon
ShotsFiredRocket: Number of shots player fired with a rocket launcher weapon
ShotsFiredSprRifle: Number of shots player fired with a sniper rifle weapon
HitsGrenade: Number of times player successfully hit an enemy with a grenade weapon
HitsAstRifle: Number of times player successfully hit an enemy with an assault rifle weapon
HitsPistol: Number of times player successfully hit an enemy with a pistol weapon
HitsMG: Number of times player successfully hit an enemy with a machine gun weapon
HitsRocket: Number of times player successfully hit an enemy with a rocket weapon
HitsSprRifle: Number of times player successfully hit an enemy with a sniper rifle weapon
KillsGrenade: Number of times player killed an enemy with a grenade weapon
KillsAstRifle: Number of times player killed an enemy with an assault rifle weapon
KillsPistol: Number of times player killed an enemy with a pistol weapon
KillsMG: Number of times player killed an enemy with a machine gun weapon
KillsRocket: Number of times player killed an enemy with a rocket weapon
KillsSprRifle: Number of times player killed an enemy with a sniper rifle weapon
UserName: Player's username
GroupID: Player's group ID (Normal player, Development Team, Beta team, active US military, etc)
UserID: User's unique identifying number
Experience: Experience points earned by this player
Honor: Honor points earned by this player
CreationDate: Date the player's account was created
LastLoginDate: Last time the player logged into the game
HoursPlayed: Total hours played by this player
FavoriteMap: Most frequently played map
AverageScore: Player's average score
BetaUser: Whether the player is a beta tester
MissionsCompleted: Total number of missions completed
RoundsWon: Total number of rounds won
RoundsLost: Total number of rounds lost
MatchesCompleted: Total number of matches completed
ObjectivesCompleted: Total number of objectives successfully completed
ObjectiveDeaths: Total number of deaths while attempting to take an objective
MedpaksApplied: Total number of medical packs the player has applied to others as a medic
TimesHealed: Total number of times the player has been healed
WeaponUseRecords: Number of weapon shots fired, shots hit, and kill totals for each weapon class (assault rifle, pistol, machine gun, sniper rifle, rocket, grenade)
ROE: Total rules of engagement violation points
Version: User's client version
QualificationRecords: Qualification date and grade for rifle marksmanship, grenade, and driver training
ToursCompletedBitset: Bitset reflecting which tours the player has completed
MissionsCompletedBitset[32]: Bitset reflecting which missions the player has completed in each tour
SquadLeaderSeconds: Time in seconds the player spent as the squad leader
FireteamLeaderSeconds: Time in seconds the player spent as the fireteam leader
SoldierSeconds: Time in seconds the player spent as a normal soldier
SquadLeaderLinkedSeconds: Time in seconds the player spent linked to the squad leader
FireteamLeaderLinkedSeconds: Time in seconds the player spent linked to the fireteam leader
SoldierLinkedSeconds: Time in seconds the player spent linked to other soldiers
MedicTourCompletionDate: Date that the player completed medic qualification tour
AirborneTourCompletionDate: Date that the player completed the airborne tour
AdvancedMarksmanshipTourCompletionDate: Date that the player completed the advanced marksmanship tour
SpecialForcesTrainingTourCompletionDate: Date that the player completed the special forces tour

FIG. 2 shows a Statistical Tracking Service (STS) server application 204 residing on STS server 102. Coupled with the application 204 are two additional statistical modules, including the Statistical Content Management Server (SCMS) 206, the Statistical Processing Server (SPS) 208, and the corresponding OLTP database 116. FIG. 2 further shows a Statistical Tracking Client Software (STCS) client application 214 residing on a client 140. Coupled with the STCS 214 are a database 212 and a client application 216.

The SCMS 206 component performs two important tasks. First, upon receipt of statistical event data from the STCS 214, it checks each statistical event against a list of received statistical definition messages received from the STCS 214. If a given event does not match any definition, it is rejected and added to a table of unknown statistical events for human analysis.

The SCMS 206 also keeps a record of what statistical data processing servers are handling data for a given statistical generation vector. The SCMS 206 routes the statistical event data to a given processing server based upon this list. This provides for data continuity when performing various statistical operations such as summation.

The SPS 208, upon receipt of statistical data from the SCMS 206, will apply the algorithm specified for use with a given type of data. An algorithm may be as simple as adding all events of a certain type and may be as complex as performing a regression analysis on the statistical data. The algorithm may also include doing nothing with certain data types. Once the algorithms have completed preprocessing the statistical data, they are then handed off to a central data repository, such as 116. The SPS 208 will continue to hold certain statistical data and algorithmic results if the statistical type requires this behavior for further reference upon receipt of additional statistical events. This data, however, will be expunged after a timed interval in order to conserve hardware resources.

As explained above, database 116 is a repository for data and includes all information necessary for performing the functions of the STS 102. Database 116 can be any commercially available database. Database 116 may further be managed by a database management system, which is an application that controls the organization, storage and retrieval of data (fields, records and files) in the databases. A database management system accepts requests for data from an application program and instructs the operating system to transfer the appropriate data. A database management system may also control the security and integrity of a database. Data security prevents unauthorized users from viewing or updating certain portions of the database. A database management system can be any commercially available database management system

In an embodiment of the present invention, the tasks performed by the SPS 208 and SCMS 206 are performed in real time during execution of the interactive 3-D simulation of system 100. An application in which information is received and immediately responded to without significant time delay is referred to as operating in real time. Real time calculations and tasks are intended to occur right away, without any perceptible delay, within certain constraints. For example, most video conferencing utilities operate in real time, as too much delay will make the system unusable. Real time tasks occur at the same time as other, usually human, activities. Events that happen in real time are happening virtually at that particular moment. When you chat in a chat room or send an instant message, for example, you are interacting in real time since it is immediate.

FIG. 2 further shows a Statistical Tracking Client Software (STCS) client application 214 residing on a client 140. Coupled with the STCS 214 are a client database 212 and a client application 216, which is the client-side portion of the simulation or video game. The STCS 214 can comprise an Application Programming Interface (API) that will allow statistical events to be generated dynamically. This can be accomplished by using two types of messages for statistical reporting. The first type of message will inform the STS 204 that a given statistic will be used, including such attributes as its name, data type and which algorithms should be used to perform various statistical services, such as collation, summation, trend analysis, etc.

The second type of message will simply be a statistic of the type already registered by the first message. All messages of the second type will not be immediately transmitted to the server-side statistical service. Instead, the messages will be held by a client 140 in a local data repository that will reside on the hard drive, such as in database 212.

This will ensure data integrity, and prevent loss of statistical data in the event of, say, a computer shutdown rather than a game exit. After a certain amount of statistical event data has been gathered or a timed interval has completed, the data will be compressed and transmitted to the STS 204. Once the STCS 214 has received a confirmation that the data has been successfully received, the local data repository will be purged of its contents in order to prepare to store new statistical events.

Each module described above on the client 140 is a client application, such as an application programmed in C++ or any self-sufficient application executing on a client computer. It should also be noted that in the embodiment of the present invention described above, the modules 204-208 are depicted as separate from modules in the client 140. In an alternative embodiment of the present invention, any one or all of the modules 204-208 and modules on the client 140 can be integrated. In this alternative embodiment, those modules that are integrated share the same resources.

Examples of statistical data sent in messages of type one and two include those statistical events described in the non-exhaustive list above. In an embodiment of the present invention, the tasks performed by the STCS 214 are performed in real time during execution of the interactive 3-D simulation of system 100.

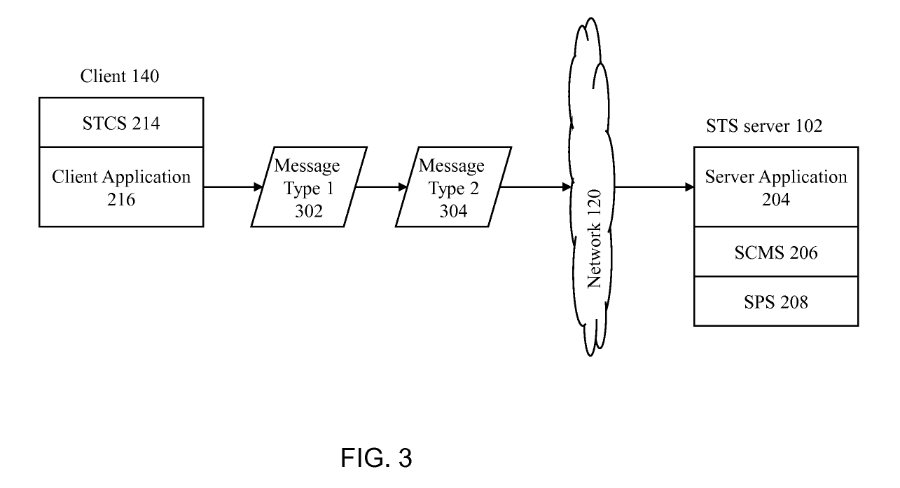

FIG. 3 is a block diagram showing a message transmission process of a statistical tracking service process of an online game system 100, according to one embodiment of the present invention. The diagram of FIG. 3 depicts the process by which a client application 216 executing at a client 140 produces and transmits (via a network 120) statistical messages 302, 304 of two different types to a server application 204 executing at STS server 120.

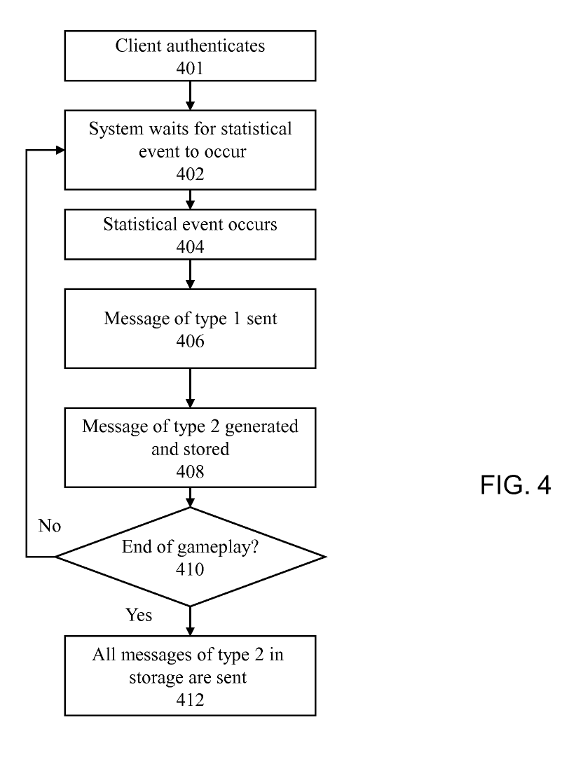

The process by which statistical messages 302, 304 of two different types are produced and transmitted is described in greater detail below with reference to FIG. 4.

FIG. 4 is a flowchart showing the control flow of the production and transmission of messages of a statistical tracking service process of an online game system 100, according to one embodiment of the present invention. The flowchart of FIG. 4 depicts the process by which a client application 216 executing at a client 140 produces and transmits statistical messages to a server application 204 executing at a server 102.

In a first step 401, the client 140 authenticates itself with the authentication server 112. See the section below pertaining to the authentication server 112 for a more detailed description of the process of authentication. In response to this authentication, the authentication server 112 sends a message, such as an IP packet, to the STS 102 indicating that the client 140 is authenticated. Upon receiving this message, the STS 102 thereby allows the collection of statistical data from the client 140.

In a first step 402, the client application 216 waits for an event to occur. An event can be any of a variety of events such as a game event including the shooting of a weapon or the commencement or conclusion of a game session. In a next step 404, such an event occurs.

Next, in step 406, in response to the occurrence of the event, a message of a first type is generated and sent to the STS server application 204. Messages of the first type inform the STS 204 that a given statistic will be used, including such attributes as its name, data type and which algorithms should be used to perform various statistical services, such as collation, summation, trend analysis, etc. Then, in step 408, in response to the occurrence of the event, a message of a second type is generated and stored. Messages of the second type are simply a statistic of the type already registered by the message of the first type.

All messages of the second type are not immediately transmitted to the STS 204. Instead, the messages of the second type are held by the STCS 214, which determines how a statistical event should be handled, such as whether the statistic should be collated, added to a summary, or simply held for transmission. The messages of the second type are held by the STCS 214 in database 212.

In step 410 it is determined whether the end of the current game session has been reached. If the result of this determination is positive, control flows to step 412. Otherwise, control flows back to step 402. In step 412, all stored messages of the second type are sent to the STS 204. In one embodiment of the present invention, if the result of the determination of step 410 is negative, control flows back to step 401 wherein the client 140 is authenticated once again and the rest of the control flow of FIG. 4 is repeated. In this embodiment, the client 140 is continually authenticated (and the authentication server 112 continually sends an authentication message to the STS server 102) during game-play.

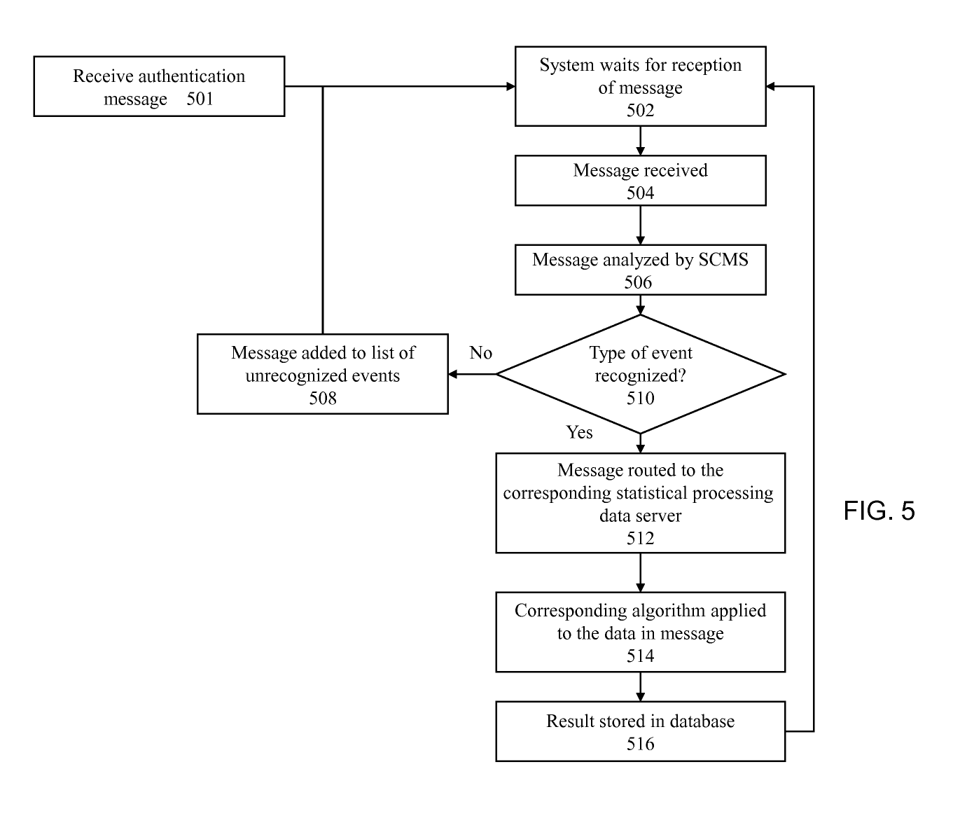

FIG. 5 is a flowchart showing the control flow of the reception and processing of messages of a statistical tracking service process of an online game system 100, according to one embodiment of the present invention. The flowchart of FIG. 5 depicts the process by which a server application 204 executing at a server 102 receives and processes statistical messages sent by a client application 216.

In a first step 501, the client 140 authenticates itself with the authentication server 112 and the authentication server 112 sends a message to the STS 102 indicating that the client 140 is authenticated. Upon receiving this message, the STS 102 thereby allows the collection of statistical data from the client 140. In step 502, the server 102 waits for reception of a message. In step 504, a message is received by the server 102.

In step 506, the message is analyzed by the SCMS 206 of the server 102. In step 510 it is determined by the SCMS 206 whether the event reported in the message that was received is recognized. If the result of the determination is positive, control flows to step 512. Otherwise, control flows to step 508. In step 508, the message, and the event it purports to report, is added to a list of unrecognized events. In step 512, SCMS 206 routes the message to the appropriate statistical processing data server. Once the message is routed to the appropriate statistical processing data server, the statistical processing data server, in step 514, applies the corresponding algorithm to the data in the message that was received.

In step 516, the results of the application of the algorithm are stored in a database, such as database 116. Then, control flows back to step 502. In one embodiment of the present invention, control flows back to step 501 after step 516, such that the STS server 102 again receives the authentication message. In this embodiment, the client 140 is continually authenticated (and the authentication server 112 continually sends an authentication message to the STS server 102) during game-play.

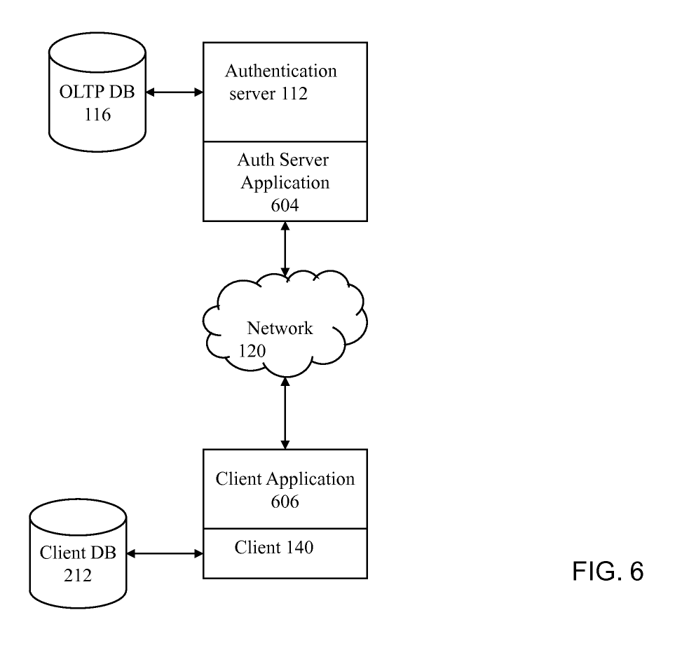

FIG. 6 is a block diagram showing a high level system architecture of an authentication process of an online game system 100, according to one embodiment of the present invention. FIG. 6 provides more detail about authentication server 112 of FIG. 1. The authentication server 112 provides persistent authentication to clients 140-142 and servers 102-110 of the simulation or video game of the system 100. Persistent authentication means that upon provision of proper credentials by a client 140, certain permissions are associated with the client 140, which permissions affect the experience of the client 140 in the simulation or video game of system 100.

The permissions pertain to access rights to specific applications, maps, areas, textures, servers, other players and/or data available on the video game or simulation of system 100. Permissions control the ability of the users of clients 140-142 to view, execute and/or make changes to certain items, such as the contents of a file system. Permissions may include the rights to read, write, execute, modify or execute an item. Permissions may also affect whether the client 140 receives certain messages.

FIG. 6 shows an authentication server application 604 residing on authentication server 112. Coupled with the application 604 is the corresponding OLTP database 116. FIG. 6 further shows an authentication client application 606 residing on a client 140. As explained above, database 116 is a repository for data and includes all information necessary for performing the functions of the authentication server 112. OLTP database 116 contains the credentials necessary for authentication of an entity. Credentials are used to control access to a game server 140, any server 102-110, databases 114-118 and the game or simulation of system 100. The combination of a user account number or name and a secret password is a widely-used example of credentials. Other examples of credentials are fingerprints, voice recognition, retinal scans, Public Key Certificate, and so on. Credentials are issued and withdrawn by the authentication server 112 for the systems in question based on criteria established or imposed by the authentication server 112.

FIG. 6 further shows an authentication client application 606 residing on a client 140—the application 606 is the client-side portion of the authentication server application 604. Coupled with the client application 606 is a client database 212. The client application 606 can comprise an API or an application programmed in C++ or any self-sufficient application executing on a client computer.

It should also be noted that in the embodiment of the present invention described above, the client application 606 is depicted as separate from the server application 604. In an alternative embodiment of the present invention, the applications 604 and 606 can be integrated. In this alternative embodiment, those applications that are integrated share the same resources. In another embodiment of the present invention, the tasks performed by the authentication server application 604 and client application 606 are performed in real time during execution of the interactive 3-D simulation of system 100.

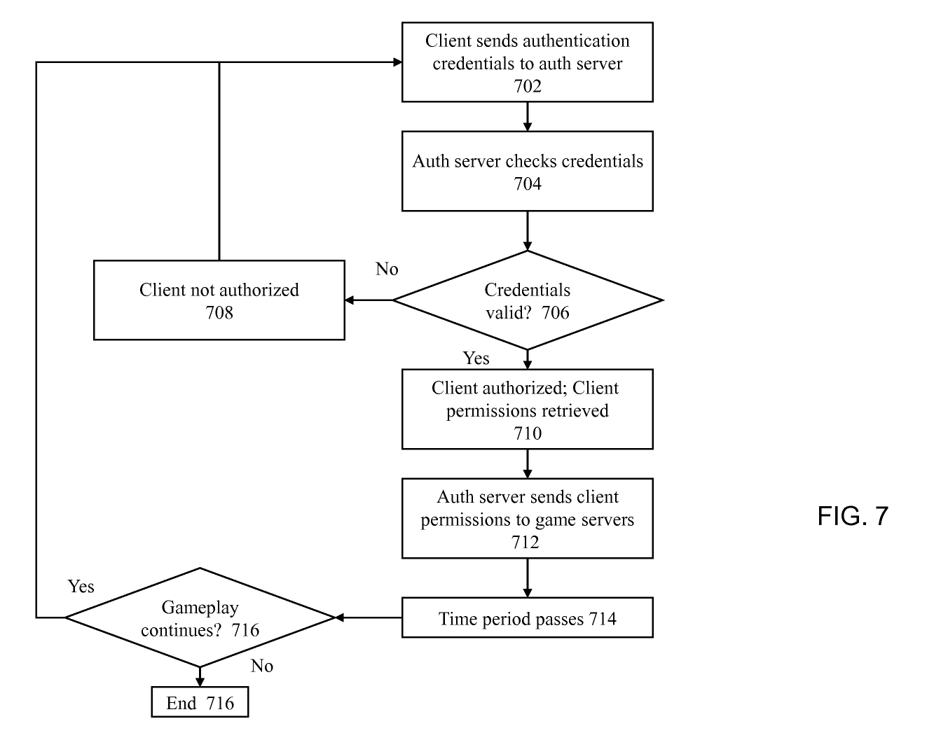

FIG. 7 is a flowchart showing the control flow of the continuous authentication process of an online game system 100, according to one embodiment of the present invention. The flowchart of FIG. 7 depicts the process by which a client authentication application 606 executing at a client 140 authenticates with the authentication server 112, which subsequently periodically authenticates the client 140 with game servers 130-132.

In a first step 702, the client authentication application 606 on client 140 sends its authentication credentials, such as a login name and password, to the authentication server application 604 on the authentication server 112. In a next step 704, the authentication server 112 checks the credentials provided by client 140 by checking them against credentials stored in a record associated with client 140, the record residing on a database, such as OLTP database 116. If the credentials are valid, control flows to step 710. Otherwise, control flows to step 708. In step 708, the client 140 is not authorized for participation with a game server 130-132.

In step 710, the client 140 is authorized for participation with a game server 130-132 and the authentication server 112 retrieves the permissions associated with client 140. The permissions may be retrieved from the same record from which the client 140 credentials were retrieved, or a record associated or linked with the same. In step 712, the authentication server 112 sends a message, such as an IP packet or a similar message, to game servers 130-132 detailing the permissions associated with client 140.

In step 714, a predetermined period of time, such as 10 seconds, is allowed to pass. In step 716, it is determined whether the client 140 is still involved or participating in the game or simulation of system 100. If the result of this determination is positive, control flows back to step 702 where the client 140 authenticates itself with the authentication server 112, which in turn sends a message to game servers 130-132. This cycle repeats itself continuously during the entire time the client 140 is participating in the game or simulation of system 100. Thus, the client 140 is periodically authenticated and the game servers 130-132 are periodically updated on permissions during game-play. If the result of the determination of step 716 is negative, control flows to step 718 where the control flow of FIG. 7 stops.

In one alternative, if the result of the determination of step 716 is positive, control instead flows back to step 712 where the authentication server 112 again sends a message to game servers 130-132. This cycle repeats itself continuously during the entire time the client 140 is participating in the game or simulation of system 100.

The permissions retrieved in step 710 and transmitted in step 712 pertain to permissions or access rights to specific applications, maps, areas, textures and/or data available on the video game or simulation of system 100.

In an optional step before step 712, each game server 130-132 authenticates itself with the authentication server 112. If a server does not authenticate itself in this optional step, the authentication server 112 does not send the game server the message of step 712. This step allows for greater security as it only allows authenticated servers to receive the list of permissions sent in step 712. The cycle of authentication of game servers repeats itself continuously during the entire time a game server is serving in the game or simulation of system 100 to clients 140-142. Thus, each game server is periodically authenticated during game-play.

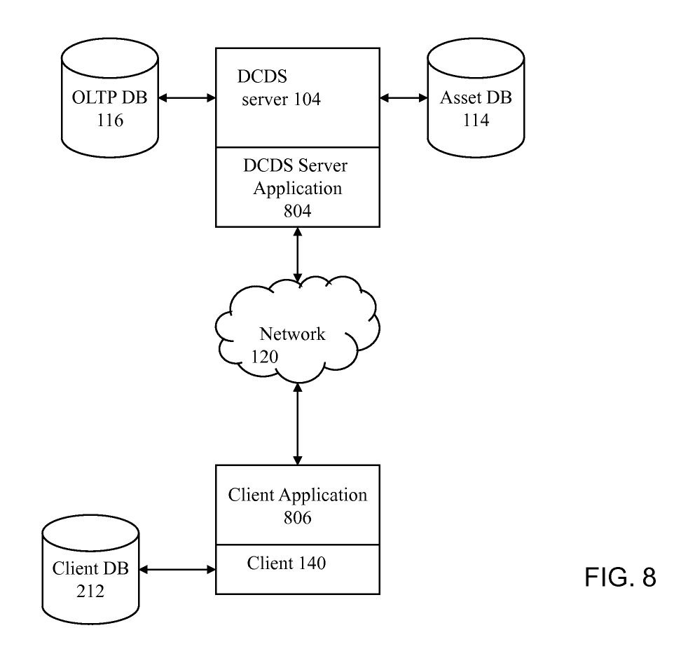

FIG. 8 is a block diagram showing a high level system architecture of a media content customization process of an online game system 100, according to one embodiment of the present invention. FIG. 8 provides more detail about DCDS server 104 of FIG. 1. The DCDS server 104 provides customized delivery of media content to clients 140-142 of the simulation or video game of the system 100 based on the statistics gathered by STS server 102. FIG. 8 shows a DCDS server application 804 residing on DCDS server 104. Coupled with the application 804 is OLTP database 116 and asset database 114. FIG. 8 further shows a DCDS client application 806 residing on a client 140.

As explained above, database 116 is a repository for data and includes information necessary for performing the functions of the DCDS server 112. Specifically, OLTP database 116 contains the statistics gathered by STS server 102, as explained in greater detail above. The statistics gathered include personal data about the user of client 140, game-play statistics of the user of client 140, and statistics pertaining to the behavior of the user of client 140 within the game or simulation of system 100.

DCDS server 104 is further connected to an asset database 114. An asset, also known as a media element, can be an image, audio, video, a texture, a 3D model, and an animation. Multiple assets are often combined into a single file, such as a binary file, called a package. Each asset and package has a name, which may be included in the package file as part of the content of the file.

FIG. 8 further shows a DCDS client application 806 residing on a client 140—the application 806 is the client-side portion of the DCDS server application 804. Coupled with the client application 806 is a client database 212. The client application 806 can comprise an API or an application programmed in C++ or any self-sufficient application executing on a client computer.

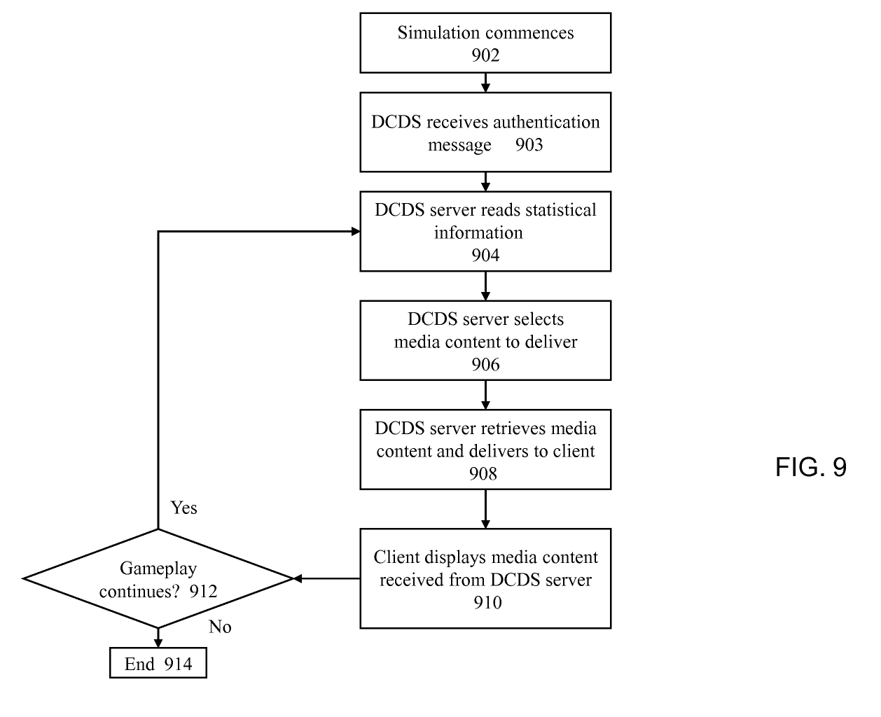

FIG. 9 is a flowchart showing the control flow of the customized media content delivery process of an online game system 100, according to one embodiment of the present invention. The flowchart of FIG. 9 depicts the process by which a DCDS server application 804 operating at DCDS server 104 provides customized delivery of media content to client DCDS application 806 executing at a client 140, wherein the media content is based on client statistics. In an embodiment of the present invention, the tasks performed by the DCDS application 804, the client application 806 and the server 104 are performed in real time during execution of the interactive 3-D simulation of system 100.

In a first step 902, the video game or simulation of system 100 commences. In step 903, the client 140 authenticates itself with the authentication server 112 and the authentication server 112 sends a message to the DCDS 104 indicating that the client 140 is authenticated. Upon receiving this message, the DCDS 104 thereby proceeds with the remainder of the control flow of FIG. 9.

In step 904, the DCDS server application 804 on server 104 reads pertinent statistical information on the OLTP database 116, which houses the statistics gathered by STS server 102, such as personal data about the user of client 140, game-play statistics of the user of client 140, and statistics pertaining to the behavior of the user of client 140 within the game or simulation of system 100. Based on the statistical data gathered in step 904, the DCDS application 804, in step 906, determines which media content to provide to the client 140.

The DCDS application 804 may follow certain pre-determined criteria for determining which media content to provide to the client 140. For example, the DCDS application 804 may have a criteria that players of a certain age, gender and location demographic (such as males of ages 17-25 from the Mid-West) will be provided with certain media content, such as an image that shall be posted on a virtual wall existing in the interactive 3-D simulation of system 100. The image may appear as a poster, billboard, monitor or poll and may advertise an event, a product or a service. Alternatively, the image may provide information that is used during the simulation for advancement in the simulation. In another alternative, the image may be a targeted advertisement.

In another example, the DCDS application 804 may have criteria that players of a certain age, gender, income and education demographic will be provided with certain media content, such as a video clip or an audio clip. The video or sound clip may be viewed during the video game or simulation. In one embodiment, the video or sound clip may comprise a recruitment pitch that is geared towards the chosen demographic.

In step 908, the DCDS application 804 retrieves the chosen media content from the asset database 114 and sends it to the client application 806, such as via an IP packet. In step 910, the client application 806 displays the media content to the use of client 140.

In step 912, it is determined whether the client 140 is still involved or participating in the game or simulation of system 100. If the result of this determination is positive, control flows back to step 904 where the DCDS server 104 again determines which media content to provide to the client 140. This cycle repeats itself continuously during the entire time the client 140 is participating in the game or simulation of system 100. Thus, the client 140 is periodically provided in real time with updated and customized media content during game-play. Furthermore, as the statistics collected by STS server 102 changes in real time, so does the media content provided by DCDS server 104. If the result of the determination of step 912 is negative, control flows to step 914 where the control flow of FIG. 9 stops.

In one embodiment of the present invention, control flows back to step 903 after step 912 (if game-play continues), such that the DCDS 104 again receives the authentication message. In this embodiment, the client 140 is continually authenticated (and the authentication server 112 continually sends an authentication message to the DCDS 104) during game-play.

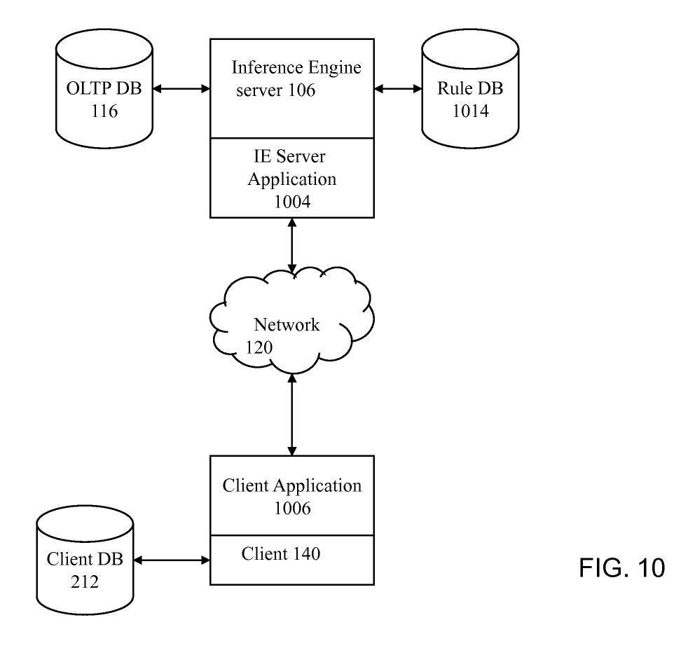

FIG. 10 is a block diagram showing a high level system architecture of an inference engine process of an online game system 100, according to one embodiment of the present invention. FIG. 10 provides more detail about inference engine server 106 of FIG. 1. The inference engine server 106 provides inference processes used in conjunction with customized delivery of media content to clients 140-142, as performed by the DCDS server 104 described in greater detail above.

An inference engine is a computer program that derives answers from a knowledge base. An inference engine reasons about the information in the knowledge base for the ultimate purpose of formulating new conclusions. This architecture of an inference engine comprises: 1) a database of symbols representing facts or assertions about the problem; and 2) a set of rules which operate upon the symbols. The inference engine must determine which rules are relevant to a given set of facts and choose which one(s) to apply. The control strategy used to select rules is often called conflict resolution.

A rule is a statement that has two parts, an if-clause and a then-clause. An example of a rule is: If the player is between 17 and 25 years old and the player is from the Mid-West, then provide the player with a certain image. Various player statistics can be taken into account, such the player's age, location, current difficulty level, education level, income level, and socioeconomic status. Any statistic gathered by the STS server 102 can further be taken into account.

The inference engine server 106 comprises a rule database made up of many such rules. They are entered as separate rules and it is the inference engine that uses them together to draw conclusions. Because each rule is a unit, rules may be deleted or added without affecting other rules (though it should affect which conclusions are reached). Execution of a rule may affect various aspects of the simulation or video game of system 100, such as difficulty level, health, speed, accuracy, artificial intelligence level of non-player characters, the size of the map being executed, clues provide to the player and objectives provided to the player.

FIG. 10 shows an inference engine server application 1004 residing on inference engine server 106. Coupled with the server 106 is OLTP database 116 and rule database 1014. FIG. 10 further shows an inference engine server client application 1006 residing on a client 140.

As explained above, database 116 is a repository for data and includes information necessary for performing the functions of the inference engine server 106. Specifically, OLTP database 116 contains the statistics gathered by STS server 102, as explained in greater detail above. The statistics gathered include personal data about the user of client 140, game-play statistics of the user of client 140, and statistics pertaining to the behavior of the user of client 140 within the game or simulation of system 100.

The inference engine server 106 is further connected to a rule database 1014. The database 1014 contains one or more sets of rules for execution upon statistical data collected by the STS server 102 and stored in OLTP database 116. FIG. 10 further shows an inference engine client application 1006 residing on a client 140—the application 1006 is the client-side portion of the inference engine server application 1004. Coupled with the client application 1006 is a client database 212. The client application 1006 can comprise an API or an application programmed in C++ or any self-sufficient application executing on a client computer.

In an embodiment of the present invention, the tasks performed by the server 106 and application 1004 are performed in real time during execution of the interactive 3-D simulation of system 100.

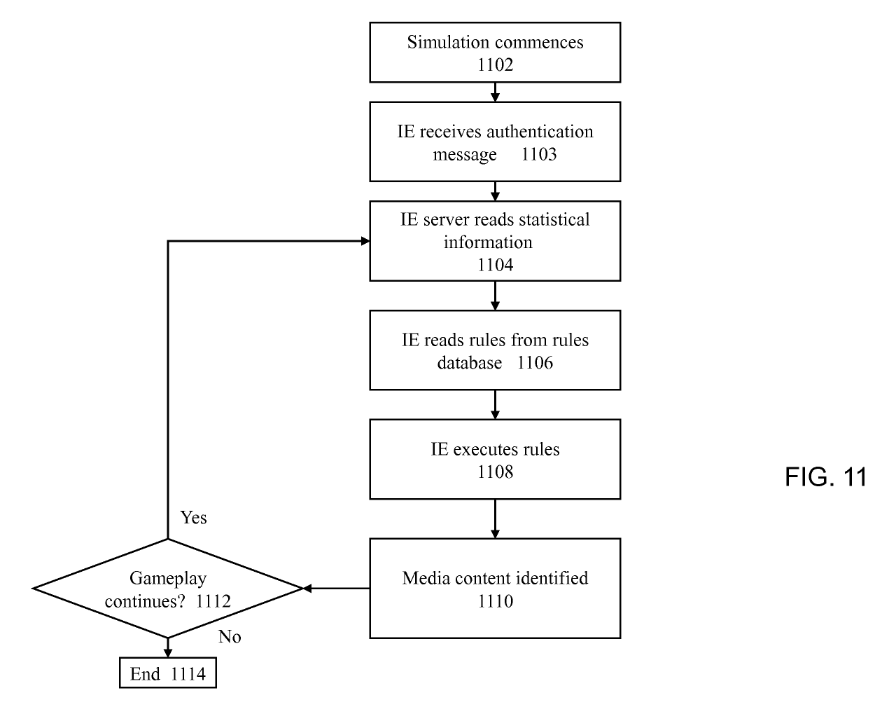

FIG. 11 is a flowchart showing the control flow of the inference engine process of an online game system 100, according to one embodiment of the present invention. The flowchart of FIG. 11 depicts the process by which inference engine server application 1004 operating at inference engine server 106 executes rules in rule database 1014 to determine the customized media content to be delivered by DCDS server 104 to client DCDS application 806 executing at a client 140, wherein the media content is based on client statistics. In short, the tasks performed by the inference engine server 106 provide more detail regarding step 906 of the control flow of FIG. 9.

In an embodiment of the present invention, the tasks performed by the inference engine server 106 and the client application 1006 are performed in real time during execution of the interactive 3-D simulation of system 100.

In a first step 1102, the video game or simulation of system 100 commences. In step 1103, the client 140 authenticates itself with the authentication server 112 and the authentication server 112 sends a message to the inference engine server 106 indicating that the client 140 is authenticated. Upon receiving this message, the inference engine server 106 thereby proceeds with the remainder of the control flow of FIG. 11.

In step 1104, the inference engine server application 1004 on server 106 reads pertinent statistical information on the OLTP database 116, which houses the statistics gathered by STS server 102, such as personal data about the user of client 140, game-play statistics of the user of client 140, and statistics pertaining to the behavior of the user of client 140 within the game or simulation of system 100. Next, in step 1106, the inference engine server application 1004 on server 106 reads pertinent rules from the rules database 1014, which houses the rules that will be executed upon the statistics read from database 116.

In step 1108, the inference engine server application 1004 on server 106 executes the pertinent rules from the rules database 1014. The result of step 1108 is the production of conclusions in step 1110, comprising the identification of media content in asset database 114 for transmission to the client application 806. Thus, based on the statistical data gathered in step 1104, the inference engine server 106, in step 1108, determines which media content to provide to the client 140.

In step 1112, it is determined whether the client 140 is still involved or participating in the game or simulation of system 100. If the result of this determination is positive, control flows back to step 1104 where the inference engine server 106 again identifies media content to provide to the client 140. This cycle repeats itself continuously during the entire time the client 140 is participating in the game or simulation of system 100. Thus, as the statistics collected by STS server 102 changes in real time, so does the media content identified by inference engine server 106. If the result of the determination of step 1112 is negative, control flows to step 1114 where the control flow of FIG. 11 stops.

In one embodiment of the present invention, control flows back to step 1103 after step 1112 (if game-play continues), such that the inference engine server 106 again receives the authentication message. In this embodiment, the client 140 is continually authenticated (and the authentication server 112 continually sends an authentication message to the inference engine server 106) during game-play.

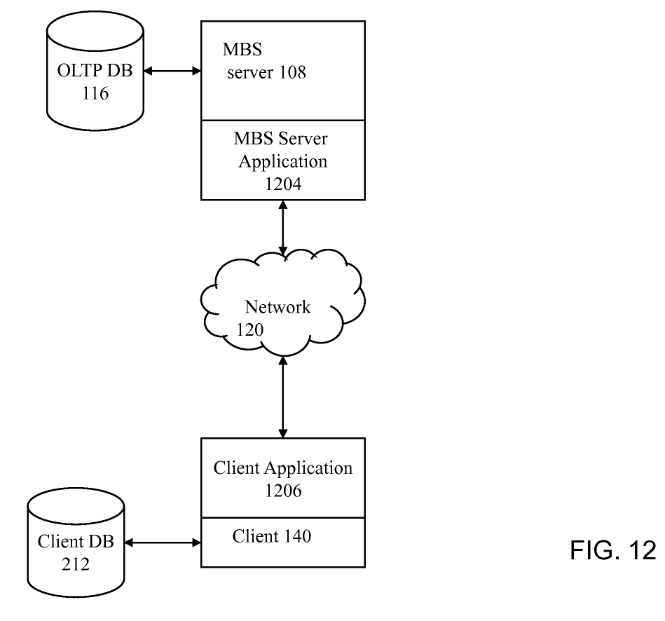

FIG. 12 is a block diagram showing a high level system architecture of a client-server matchmaking process of an online game system 100, according to one embodiment of the present invention. FIG. 12 provides more detail about MBS server 108 of FIG. 1. The MBS server 108 selects for each client application (140-142) a game server (130-132) that provides optimal game performance to each client application and directs each client application to a game server that was selected for that client application.

FIG. 12 shows an MBS server application 1204 residing on MBS server 108. FIG. 10 further shows an MBS client application 1206 residing on a client 140. Coupled with the server 108 is OLTP database 116. As explained above, database 116 is a repository for data and includes information necessary for performing the functions of the MBS server 108. Specifically, OLTP database 116 contains the statistics gathered by STS server 102, as explained in greater detail above. The statistics gathered by STS 102 further include, for each game server 130-132, location data, downtime data, load data, latency data, processing power data, available bandwidth data, memory usage data, resource usage data and related server performance data. The statistics gathered by STS 102 further include similar and/or identical performance data for each client 140 participating in the game or simulation of system 100.

FIG. 12 further shows an MBS client application 1206 residing on a client 140—the application 1206 is the client-side portion of the MBS server application 1204. Coupled with the client application 1206 is a client database 212. The client application 1206 can comprise an API or an application programmed in C++ or any self-sufficient application executing on a client computer. In an embodiment of the present invention, the tasks performed by the server 108 and application 1204 are performed in real time during execution of the interactive 3-D simulation of system 100.

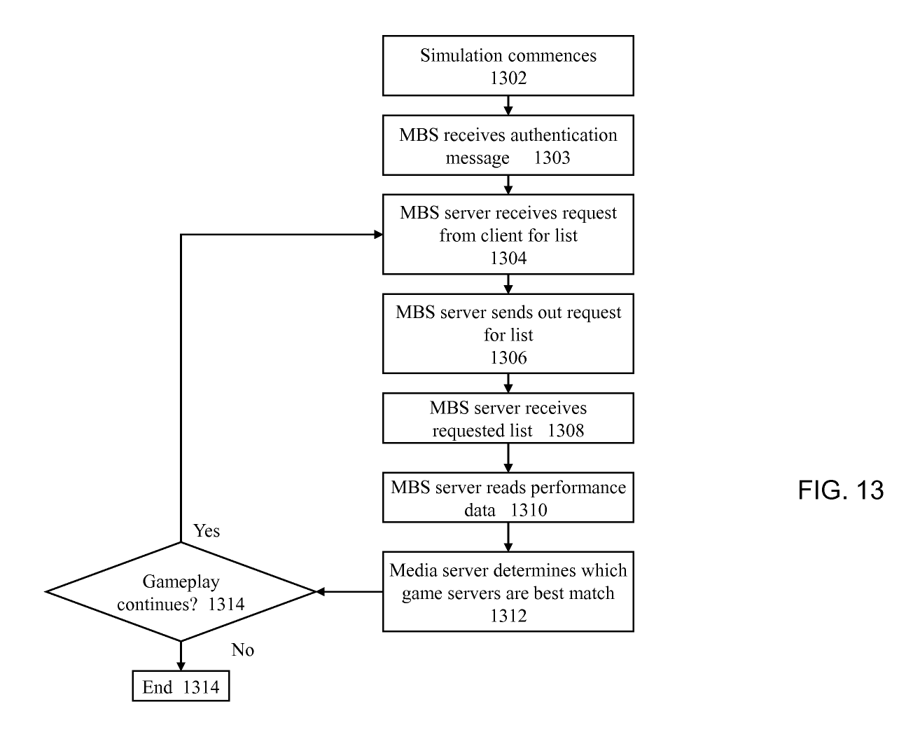

FIG. 13 is a flowchart showing the control flow of the client-server matchmaking process of an online game system 100, according to one embodiment of the present invention. The flowchart of FIG. 13 depicts the process by which MBS server 108 selects for each client application (140-142) a game server (130-132) that provides optimal game performance to each client application and then directs each client application to the selected game server.

In a first step 1302, the video game or simulation of system 100 commences. In step 1303, the client 140 authenticates itself with the authentication server 112 and the authentication server 112 sends a message to the MBS server 108 indicating that the client 140 is authenticated. Upon receiving this message, the MBS server 108 thereby proceeds with the remainder of the control flow of FIG. 13.

In step 1304, the client application 1206 on client 140 sends a request, such as via an IP packet, to the MBS server application 1204 demanding a list of operational game servers serving the interactive 3-D simulation or video and an address for each of the operational game servers. In step 1306, the MBS server application 1204 sends a request, such as via an IP packet, to the authentication server 112 demanding a list of recently authenticated game servers serving the interactive 3-D simulation or video and an address for each of the operational game servers. Recall in the control flow of FIG. 7 that game servers 130-132 may periodically authenticate themselves with the authentication server 112 during execution of the video game or simulation of system 100. In step 1308, the authentication server 112 sends to the MBS server application 1204 a list of recently authenticated game servers serving the interactive 3-D simulation or video and an address for each of the operational game servers.

Note that the MBS server application 1204 receives a list of recently authenticated game servers, which is vastly different from a list of game servers that respond to a ping. A ping is a computer network tool used to test whether a particular host is reachable across an IP network. The ping feature works by sending ICMP “echo request” packets to the target host and listening for ICMP “echo response” replies. A game server that responds to a ping simply confirms that the game server is online and its network facilities functioning. A game server that responds to a ping does not confirm that the game server is currently serving an interactive multi-player video game or simulation over a network 120. The list of recently authenticated game servers received by the MBS server application 1204 confirms the listed game servers are currently serving the video game or simulation of system 100 over a network 120.

In step 1310, the MBS server application 1204 on server 108 reads pertinent statistical information on the OLTP database 116, which houses the statistics gathered by STS server 102, such as performance data of game servers 130-132 and clients 140-142. Next, in step 1312, the MBS server application 1304 on server 106 determines which of the listed game servers (that were included in the list of recently authenticated game servers received from the authentication server 112 in step 1308) would provide optimal video game or simulation performance to the client 140.

The determination of step 1312 is performed by the MBS server 108 by taking a variety of factors into account, such as the location of the requesting client, the average load of the requesting client, the average latency of the requesting client, available processing power of the requesting client, available bandwidth of the requesting client, current memory usage of the requesting client, current resource usage of the requesting client and related performance data of the requesting client.

Other factors taken into account include the location of a game server, the average load of a game server, the average down time of a game server, the average latency of a game server, available processing power of a game server, available bandwidth of a game server, current memory usage of a game server, current resource usage of a game server and related performance data of a game server.

In one embodiment of the present invention, the determination of step 1312 is performed by the MBS server 108 by determining a numerical value for each of the above factors for the requesting client and calculating a sum of all the numerical values. Then, the MBS server 108 determines a numerical value for each of the above factors for each game server and calculates a sum of the numerical values for each game server. Then, the MBS server 108 selects those game servers with a sum value similar to or within a threshold value of the requesting client's sum value.

Subsequently in step 1314, the MBS server 108 provides the list of game servers and their addresses to the client 140, wherein the client 140 may choose any one of the game servers presented.

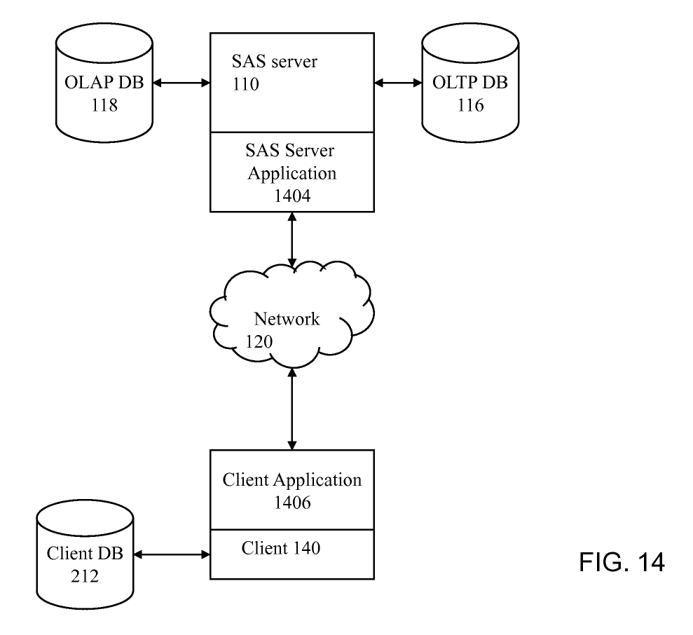

FIG. 14 is a block diagram showing a high level system architecture of a statistical data analysis process of an online game system 100, according to one embodiment of the present invention. FIG. 14 provides more detail about SAS server 110 of FIG. 1. SAS server 110 performs statistical data displaying and analysis functions, together with user access functions, described in greater detail below. The SAS server 110 provides various privileged views and displays of statistical data collected by the STS server 102 and provides analysis of the same statistical data.

FIG. 14 shows an SAS server application 1404 residing on SAS server 110. FIG. 14 further shows an SAS client application 1406 residing on a client 140. Coupled with the server 110 is an OLAP database 118 and OLTP database 116. As explained above, each database 116, 118 is a repository for data and include information necessary for performing the functions of the SAS server 110. Specifically, OLTP database 116 contains raw data gathered by STS server 102 and OLAP database 118 contains analytical data produced from the statistics gathered by STS server 102.

FIG. 14 further shows an SAS client application 1406 residing on a client 140—the application 1406 is the client-side portion of the SAS server application 1404. Coupled with the client application 1406 is a client database 212. The client application 1406 can comprise an API or an application programmed in C++ or any self-sufficient application executing on a client computer. In an embodiment of the present invention, the tasks performed by the server 110 and application 1404 are performed in real time during execution of the interactive 3-D simulation of system 100.

In an embodiment of the present invention, the SAS server 110 may display the results of analysis of statistical data collected by the STS server 102, such as the data below:
A list of servers online, shown by type, performance metric, software version, number of users connected, status and/or location
A list of clients online shown by name, group, location, software version, time on server date of first participation and/or number of game segments played.
A list of countries on which game servers reside, shown by country name, country flag, region name, and/or status of server.
A list of simulation maps available, shown by name and/or type.
A list of clients shown by date of first participation, number of game segments played.

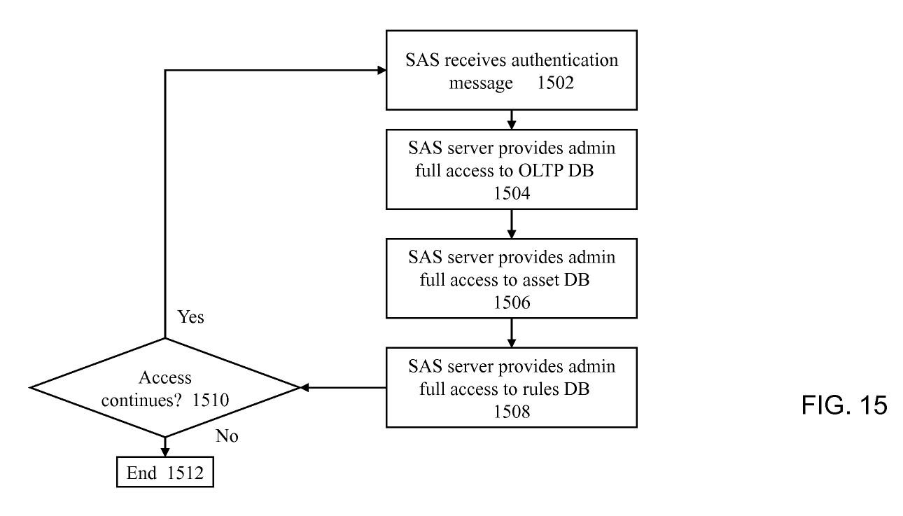

FIG. 15 is a flowchart showing the control flow of the user access process of an online game system 100, according to one embodiment of the present invention. The flowchart of FIG. 15 depicts the process by which SAS server 110 provides privileged access to a user such as a system administrator. A system administrator is typically a person employed to maintain, and operate a computer system or network. System administrators may be members of an information technology department. System administrators are usually charged with installing, supporting, and maintaining servers or other computer systems, and planning for and responding to service outages and other problems. In an embodiment of the present invention, the tasks performed by the SAS server 110 are performed in real time during execution of the interactive 3-D simulation of system 100.

In a first step 1502, the administrator authenticates itself with the authentication server 112 and the authentication server 112 sends a message to the SAS server 110 indicating that the administrator is authenticated. Upon receiving this message, the SAS server 110 thereby proceeds with the remainder of the control flow of FIG. 15.

In step 1504, the SAS server 110 provides to the administrator full access, including all permissions, to statistical information on the OLTP database 116, which houses the statistics gathered by STS server 102, such as personal data about users, game-play statistics of users, and statistics pertaining to the behavior of users within the game or simulation of system 100. The administrator is further provided with full access to create, modify or delete user or client accounts.

In step 1506, the SAS server 110 provides to the administrator full access, including all permissions, to the assets in asset database 114, which houses the assets utilized by the DCDS server 104, described in greater detail above. For each user of the interactive 3-D simulation or video game of system 100, the DCDS server 104 selects media content from the asset database 114 in real time during execution of the interactive 3-D simulation, wherein the media content is selected based on the data that was collected about the user by STS server 102. Subsequently, the DCDS server 104 provides the media content in real time to the user during execution of the interactive 3-D simulation.

In step 1508, the SAS server 110 provides to the administrator full access, including all permissions, to the rules database 1014, which houses the rules used by the DCDS server 104 for determining how media content is provided to clients of the interactive 3-D simulation.

In step 1510, it is determined whether the administrator is still accessing any of the items to which he has been given access by SAS server 110. If the result of this determination is positive, control flows back to step 1502 where the administrator is authenticated again. This cycle repeats itself continuously during the entire time the administrator is accessing any of the items to which he has been given access by SAS server 110. Thus, the administrator is continually authenticated and the authentication server 112 continually sends an authentication message to the SAS server 110. If the result of the determination of step 1510 is negative, control flows to step 1512 where the control flow of FIG. 15 stops.

FIG. 16 is a block diagram showing an embodiment of a computer system 1600 useful for implementing an embodiment of the present invention. The present invention can be realized in hardware, software, or a combination of hardware and software in the system described in FIG. 16. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium.

The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

FIG. 16 is a block diagram of a computer system useful for implementing an embodiment of the present invention. The computer system 1600 of FIG. 16 is a more detailed representation of the computers and servers of FIG. 1. The computer system 1600 of FIG. 16 includes one or more processors, such as processor 1604. The processor 1604 is connected to a communication infrastructure 1602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system 1600 can include a display interface 1608 that forwards graphics, text, and other data from the communication infrastructure 1602 (or from a frame buffer not shown) for display on the display unit 1610. The computer system 1600 also includes a main memory 1606, preferably random access memory (RAM), and may also include a secondary memory 1612. The secondary memory 1612 may include, for example, a hard disk drive 1614 and/or a removable storage drive 1616, representing a floppy disk drive, a magnetic tape drive, an optical disk drive, etc.

The removable storage drive 1616 reads from and/or writes to a removable storage unit 1618 in a manner well known to those having ordinary skill in the art. Removable storage unit 1618, represents, for example, a floppy disk, magnetic tape, optical disk, etc. which is read by and written to by removable storage drive 1616. As will be appreciated, the removable storage unit 1618 includes a computer usable storage medium having stored therein computer software and/or data.

In alternative embodiments, the secondary memory 1612 may include other similar means for allowing computer programs or other instructions to be loaded into the computer system. Such means may include, for example, a removable storage unit 1622 and an interface 1620. Examples of such may include a program cartridge and cartridge interface (such as that found in video game devices), a removable memory chip (such as an EPROM, or PROM) and associated socket, and other removable storage units 1622 and interfaces 1620 which allow software and data to be transferred from the removable storage unit 1622 to the computer system.

The computer system may also include a communications interface 1624. Communications interface 1624 allows software and data to be transferred between the computer system and external devices. Examples of communications interface 1624 may include a modem, a network interface (such as an Ethernet card), a communications port, a PCMCIA slot and card, etc. Software and data transferred via communications interface 1624 are in the form of signals which may be, for example, electronic, electromagnetic, optical, or other signals capable of being received by communications interface 1624. These signals are provided to communications interface 1624 via a communications path (i.e., channel) 1626. This channel 1626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1606 and secondary memory 1612, removable storage drive 1616, a hard disk installed in hard disk drive 1614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information.

Computer programs (also called computer control logic) are stored in main memory 1606 and/or secondary memory 1612. Computer programs may also be received via communications interface 1624. Such computer programs, when executed, enable the computer system to perform the features of the present invention as discussed herein. In particular, the computer programs, when executed, enable the processor 1604 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method executed on a server of an interactive 3-D simulation, the method for providing customized data to clients of the server during execution of the interactive 3-D simulation, comprising:
receiving a message from an authentication source indicating authentication of the client;
reading personal data and behavioral data of a user on the client, wherein reading is performed in real time during execution of the interactive 3-D simulation and wherein the behavioral data pertains to the user's interaction with the interactive 3-D simulation;
selecting media content from a repository in real time during execution of the interactive 3-D simulation, wherein the media content is selected based on the personal data and the behavioral data that was collected; and
providing the media content in real time to the client during execution of the interactive 3-D simulation.

2. The method of claim 1, wherein the step of receiving comprises:
receiving a message from an authentication source indicating authentication of the client, wherein the message comprises an IP packet containing information in text format.

3. The method of claim 2, wherein the step of reading comprises:
reading from a record on a first database both personal data and behavioral data of a user on the client, wherein reading from the first database is performed in real time during execution of the interactive 3-D simulation and wherein the behavioral data pertains to the user's interaction with the interactive 3-D simulation.

4. The method of claim 3, wherein the step of selecting comprises:
selecting media content from a second database in real time during execution of the interactive 3-D simulation, wherein the media content is selected based on the personal data and the behavioral data that was collected.

5. The method of claim 4, wherein the step of providing comprises:
sending to the client the media content via IP packets in real time during execution of the interactive 3-D simulation.

6. A computer readable medium comprising computer instructions for execution on a server of an interactive 3-D simulation, the computer instructions for providing customized data to clients of the server during execution of the interactive 3-D simulation, the computer instructions comprising instructions for:
receiving a message from an authentication source indicating authentication of the client;
reading personal data and behavioral data of a user on the client, wherein reading is performed in real time during execution of the interactive 3-D simulation and wherein the behavioral data pertains to the user's interaction with the interactive 3-D simulation;
selecting media content from a repository in real time during execution of the interactive 3-D simulation, wherein the media content is selected based on the personal data and the behavioral data that was collected; and
providing the media content in real time to the client during execution of the interactive 3-D simulation.

7. The computer readable medium of claim 6, wherein the instructions for receiving comprise instructions for:
receiving a message from an authentication source indicating authentication of the client, wherein the message comprises an IP packet containing information in text format.

8. The computer readable medium of claim 7, wherein the instructions for reading comprise instructions for:
reading from a record on a first database both personal data and behavioral data of a user on the client, wherein reading from the first database is performed in real time during execution of the interactive 3-D simulation and wherein the behavioral data pertains to the user's interaction with the interactive 3-D simulation.

9. The computer readable medium of claim 8, wherein the instructions for selecting comprise instructions for:
selecting media content from a second database in real time during execution of the interactive 3-D simulation, wherein the media content is selected based on the personal data and the behavioral data that was collected.

10. The computer readable medium of claim 9, wherein the instructions for providing comprise instructions for:
sending to the client the media content via IP packets in real time during execution of the interactive 3-D simulation.

11. A server of an interactive 3-D simulation for providing customized data to clients of the server during execution of the interactive 3-D simulation, comprising:
a receiver for receiving a message from an authentication source indicating authentication of the client;
a database containing personal data and behavioral data of a user on the client, wherein the server reads personal data and behavioral data of the user in real time during execution of the interactive 3-D simulation and wherein the behavioral data pertains to the user's interaction with the interactive 3-D simulation;
a processor configured for selecting media content from a repository in real time during execution of the interactive 3-D simulation, wherein the media content is selected based on the personal data and the behavioral data that was collected; and
a transmitter for sending the media content in real time to the client during execution of the interactive 3-D simulation.

12. The server of claim 11, wherein the message comprises an IP packet containing information in text format.

13. The server of claim 12, wherein the database further comprises a database management system for managing the database.

14. The server of claim 13, wherein the repository comprises a database.

15. The server of claim 14, wherein the media content is sent via IP packets.
